(19) United States
(12) Patent Application Publication
(10) Pub. No.: US 2011/0069869 A1
(43) Pub. Date: Mar. 24, 2011

(54) SYSTEM AND METHOD FOR DEFINING AN ACTIVATION AREA WITHIN A REPRESENTATION SCENERY OF A VIEWER INTERFACE

(75) Inventors: Tatiana Aleksandrovna Lashina, Eindhoven (NL); Igor Berezhnoy, Eindhoven (NL)

(73) Assignee: KONINKLIJKE PHILIPS ELECTRONICS N.V., EINDHOVEN (NL)

(21) Appl. No.: 12/992,094

(22) PCT Filed: May 7, 2009
(86) PCT No.: PCT/IB09/51873

§ 371 Date: Nov. 11, 2010

(30) Foreign Application Priority Data
May 14, 2008 (EP) 08103954.7

(51) Int. Cl. G06K 9/00

(52) U.S. Cl. 382/103

(57) ABSTRACT

The invention describes a system (1) and a method for defining an activation area (3) within a representation scenery (5) of a viewer interface, which activation area (3) represents an object (7a, 7b, 7c) in an exhibition scenery (9), in particular in the context of an interactive shop window, whereby the representation scenery (5) represents the exhibition scenery (9). The system comprises a registration unit (11) for registering the object (7a, 7b, 7c), a measuring arrangement (13a, 13b) for measuring co-ordinates (CO) of the object (7a, 7b, 7c) within the exhibition scenery (9), a determination unit (15) for determining a position of the activation area (3) within the representation scenery (5), which determination unit (15) is realized to assign representation co-ordinates (RCO) to the activation area (3) which are derived from the measured co-ordinates (CO) of the object (7a, 7b, 7c) and a region assignment unit (17) for assigning a region (19) to the activation area (3) at the position of the activation area (3) within the representation scenery (5). Furthermore, the invention concerns an exhibition system.

### FIELD OF THE INVENTION

The invention concerns a method for defining an activation area within a representation scenery of a viewer interface which activation area represents an object in an exhibition scenery. Furthermore, the invention concerns a system for defining such activation area within a representation scenery.

### BACKGROUND OF THE INVENTION

Co-ordinators of exhibition sceneries, such as interactive shop windows or museum exhibition sceneries, are confronted with an ever-increasing need to frequently re-arrange their exhibition settings. In such an interactive setting, new arrangements of physical exhibition scenes also imply setting up the new scene in an interactive parallel world.

For example, an interactive shop window consists of the shop window on the one hand and a representation scenery which represents the shop window in a virtual way. This representation scenery will comprise activation areas which can be activated by certain viewer actions such as pointing at them or even just gazing, as will be described below. Once the arrangement in the shop window is altered, there will also be the necessity to alter the settings in the corresponding representation scenery, in particular the properties of the activation areas such as location and shape. While re-arrangement of a common shop window can be performed by virtually any co-ordinator, particularly by shop window decorators, the re-arrangement of an interactive scenery within a representation scenery system usually requires more specialized skills and tools and takes relatively much time.

Today's interactive shop windows are supplied with a multitude of possible technical features which enable the system and a viewer to interact. For instance, gaze tracking, a system which allows to follow a viewer's gaze at certain objects, is such feature. Such a gaze tracking system is described in WO 2007/015200 A2. Gaze tracking can be further enhanced by a recognition system as described in WO 2008/012717 A2, which make it possible to detect the products most looked at by a viewer by analyzing cumulative fixation time and subsequently triggering output of information on those products on the shop window display. WO 2007/141675 A1 goes even further by using a feedback mechanism for highlighting selective products using different light-emitting surfaces. What is common to all of these solutions is the fact that at least a camera system is used in order to monitor a viewer of an interactive shop window.

In the light of the afore-mentioned obstacles which are encountered when a window shop decorator or indeed any other co-ordinator wants to alter an exhibition scenery and in consideration of the technical features which are often present in such interactive sceneries, the object of the invention is to create a simpler and reliable possibility of how to arrange such a representation scenery, and in particular of how to define activation areas within such context.

### SUMMARY OF THE INVENTION

To this end, the present invention describes a system for defining an activation area within a representation scenery of a viewer interface, which activation area represents an object in an exhibition scenery whereby the representation scenery represents the exhibition scenery, which system comprises a registration unit for registering the object, a measuring arrangement for measuring co-ordinates of the object within the exhibition scenery, a determination unit for determining a position of the activation area within the representation scenery, which determination unit is realized to assign representation co-ordinates to the activation area which are derived from the measured co-ordinates of the object, a region assignment unit for assigning a region to the activation area at the position of the activation area within the representation scenery. The system is preferably applied in the context of an interactive shop window.

The system according to the invention may be part of an exhibition system with a viewer interface for interactive display of objects in the context of an exhibition scenery with an associated representation scenery, whereby the latter represents the former.

The exhibition scenery may contain physical objects, but also non-tangible objects such as light projections or inscriptions within the exhibition surroundings. The activation areas of the representation scenery would typically be virtual, software-based objects, but can also be built up entirely of physical objects or indeed a mixture of non-tangible and tangible objects. Activation areas can generally be used for activation of functions of any kind. Amongst these count, but not exclusively, the activation of displays of information and graphics, the output of sounds or the activation of other actions, but it may also comprise a mere indicative function, such as a light beam which is directed to a particular area—preferably the one which corresponds with the activation area—or similar display functions.

The representation scenery may be represented on a display of a viewer interface. For example, such display can be a touchpanel located on a part of a window pane of an interactive shop window. A viewer can look at the objects in the shop window and interact with the interactive system by pressing buttons on the touchpanel. The touchpanel screen may e.g. give additional information on the objects displayed in the shop window.

On the other hand, the representation scenery may also be located in the same space, but in a virtual way, as the exhibition scenery. For example, in an interactive shop window environment—but not limited to such application—the objects or activation areas of representation scenery may be located, in the form of invisible virtual shapes, at the same places as corresponding objects of the real exhibition scenery. Thus, once a viewer looks at an object within the exhibition scenery, a gaze tracking system will locate whether the viewer looks at a real object, that means the gaze strikes the virtual activation area of the representation scenery which corresponds to that very real object of the exhibition scenery, and the activation area may be activated.

Generally, a viewer interface is any kind of user interface for a viewer. Thereby, a viewer is considered to be such person who uses the viewer interface as a source of information, e.g. in a shop window context to get information about the objects that are sold by that shop or in a museum exhibition or a trade fair exhibition context to get information about the meaning and functions of displayed objects or any other content related to the objects, like advertisements, related accessories or other related products, etc. In contrast, a co-ordinator will be such person who arranges the representation scenery, i.e. typically a shop window assistant or a museum curator or an exhibitor at a trade fair. In this context, one might need to distinguish between a first person who just furnishes the exhibition scenery and a co-ordinator who arranges or organizes the setting of the representation scenery. In most cases these two tasks will be performed by the same person, but not necessarily in all cases.

The viewer interface can be a purely graphical user interface (GUI) and/or a tangible user interface (TUI) or a mixture of both. For instance, activation areas can be realized by representational objects such as cubes which represent objects in the exhibition scenery, as it might e.g. be the case within a museum context. For example, hands-on experiments within an access-restricted exhibition environment can be conducted by a museum visitor, i.e. a viewer, by handling representative objects in a parallel representation scenery: These objects may e.g. represent different chemicals which are on display in the exhibition scenery, and the viewer can mix those chemicals by putting the corresponding representative objects into a particular container which represents a test tube. As a reaction these chemicals can be mixed in reality within the exhibition scenery and the effect of the mixture will be visible to the viewer. However, it might also be possible to conduct a virtual mixing procedure which is merely displayed on a computer screen. In the latter case, the exhibition scenery only serves to display the real ingredients, the representation scenery serves as the input part of the viewer interface and the computer display serves as its output part. Many more similar examples can be thought of.

In the context of such possible settings, the system for defining an activation area utilizes its above-mentioned components by way of a method according to the invention: a method for defining an activation area within a representation scenery of a viewer interface, which activation area represents an object in an exhibition scenery, in particular in the context of an interactive shop window, whereby the representation scenery represents the exhibition scenery, which method comprises registering the object, measuring co-ordinates of the object within the exhibition scenery, determining a position of the activation area within the representation scenery by assigning to it representation co-ordinates derived from the measured co-ordinates of the object, assigning a region to the activation area at the position of the activation area within the representation scenery.

The registration unit registers an object, i.e. it defines an object as the one to be measured. For that purpose it receives data input, e.g. directly by a co-ordinator or from the measurement arrangement, e.g. about an object's presence and/or its nature. For example, once a new product is on display in a shop window or in a museum exhibition, the registration unit receives information that there is such new product and—if wished for—additionally about the kind of product. This registration step can be initiated automatically by the system or on demand by a co-ordinator. After that, the co-ordinates of the object within the exhibition scenery are measured preferably with respect to at least one reference point or reference area in the context of the exhibition scenery. Any co-ordinate system can be used, preferably a 3D co-ordinate system. For example a Cartesian system or a polar coordinate system with a reference point as its origin. Accordingly, the representation co-ordinates of the activation area which are derived from the co-ordinates of the object then also refer to a projective reference point or a projective reference area in the representation scenery. The representation co-ordinates are preferably the co-ordinates of the object which are transferred into the environment of the representation scenery, i.e. they are usually multiplied with a certain factor and refer to a projective reference point or projective reference area the position of which is in analogy with the position of the reference point/reference area of the exhibition scenery. That means that a projection of the position of the object to the representation scenery is performed. In a last step, a region, e.g. a shape or an outline, of the activation area is defined.

The system and/or the method according to the invention enables a co-ordinator to define automatically an activation area within a representation scenery. Depending on the degree of additional technical means available, this definition process can be fully automatized or partly. It can be controlled by virtually any co-ordinator and yet provides for a high degree of reliability.

In a preferred embodiment, the system comprises at least one laser device for measuring the co-ordinates of the object. Such laser device can be provided with a step motor to adjust it to the desired pointing direction. The laser device can also be used for other purposes if not in use within the framework of the method according to the invention, e.g. for pinpointing at objects in the exhibition scenery, particularly in the context of an interaction of a viewer with an interactive environment. A laser device can serve to measure the angles of a line connecting a reference point (namely the position of the laser) with the object. In addition, one can either measure the distance by use of different measuring means or by using the same laser as a laser meter (laser range-finder) or by using another laser device which also provides for angles of a second line from a second reference point to the object. These angle data from two lasers will suffice as co-ordinates which can be transferred to the reference scenery, for example using triangulation.

In addition or complementarily, the system preferably comprises at least one ultrasonic measuring device for measuring the co-ordinates of the object. It can mainly serve as a distance measuring device and thus provide additional information for a system based on one laser only. It can measure the distance of the line between the laser device and the object. Again, it is also possible to use more than one ultrasonic measuring device and thus to get two distance values which would be enough to determine the co-ordinates of the object, for example by triangulation.

It is furthermore particularly preferred to have a system which comprises at least one measuring device which is directly or indirectly controlled by a co-ordinator for measuring the co-ordinates of the object. For example, a co-ordinator can remotely control—e.g. by using a joystick—a laser device and/or an ultrasonic measuring device in order to direct its focus to an object of which he desires to define a representative activation area in a representation scenery. With such means, the co-ordinator can select explicitly those objects which he chooses to focus on, e.g. new objects in an exhibition scenery. In the case of the use of a laser device, the co-ordinator can see a laser dot on the object he intends to select and when he considers the centre of the object is aligned with the laser line he can confirm his selection. Then he can assign object identification data from a list of detected objects to the point he has just defined with the laser.

The region assigned to the activation area can have a purely functional shape, such as a cube shape or indeed any other geometrical shape with at least two dimensions, preferably three dimensions. Preferably, however, the system according to the invention is realized to derive the region which is assigned to the activation area from the shape of the object. That means in return that the region which is assigned to the activation area will have properties derived from the shape of the object. This can be the mere dimensional characteristics and/or a rough outline of the object but may also include some parts which would be outside the mere shape of the object, for example an outline slightly increased in size.

The shape of the object can be estimated by a co-ordinator and the region of the activation area adjusted accordingly in a manual way. However, preferably, an image recognition system with at least one camera and an image recognition unit is integrated in the system, which determines the shape of the object. Such camera can be used for other purposes than only for the method according to the invention, such as head and/or gaze tracking of a viewer or security monitoring of the environment of the interactive shop window. Therefore, often without any additional technical installations such image recognition can be realized. In the context of such image recognition system, it is advantageous if such image recognition system is realized to register the object, and particularly its presence and/or nature, by background subtraction. This can be done by generating a background image, i.e. an image of the exhibition scenery without the object and a second image including the object in the exhibition scenery. By subtraction of the image data the object image data will remain as a result, from which the shape of the object can be derived. Alternatively, the shape of the object can be determined by a system comprising at least two cameras, which creates a stereo image or 3D image.

Usually an exhibition scenery will be a three-dimensional setting. In this context it is highly advantageous for the system to comprise a depth analysis arrangement for a depth analysis of the exhibition scenery, such as a 3D camera or several cameras as mentioned before. With such depth analysis it is also possible to correctly localize several objects which are situated behind one another and to estimate the depth of objects.

With respect to the aforementioned optical devices such as laser devices, ultrasonic measuring devices and cameras, a preferred embodiment of the invention implies a positioning of at least one, preferably all optical devices used in the context of the invention in such way that they cannot be occluded by any of a number of objects positioned within the exhibition scenery, e.g. by selecting a position above all objects and/or at the side of the objects. The most preferred position, however, is one above the objects, in between a typical position of a viewer and the positions of the number objects. This preferred choice of position also applies to all optical devices referred to later in this context unless explicitly stated.

Furthermore, a system according to the invention preferably comprises a co-ordinator interface for display of the co-ordinates and/or region assigned to the activation area to a co-ordinator for modification. With such a user interface and the possibility of modification, a co-ordinator can re-adjust the settings of the representation scenery, e.g. by shifting the position of the activation area and/or its region with a mouse-controlled cursor on a computer display. This ensures that a co-ordinator can arrange the setting of the representation scenery in such way that no collisions between different activation areas can occur in an interactive usage. In particular, the distance between activation areas can be adjusted, also in respect to a 3D arrangement of objects and thus activation areas.

The co-ordinator interface may also, but need not necessarily be used as a viewer interface as well. It can also be locally separable from the exhibition scenery, e.g. located on a stationary computer system or laptop computer or any other suitable interface device.

A system according to the invention further preferably comprises an assignment arrangement to assign object-related identification information to the object and to its corresponding activation area. Amongst object-related identification information counts any information which specifies the object in any way. Therefore, it can include a name, price, code numbers, symbols and sounds as well as advertisement slogans, additional proprietary information, and many more, in particular information for retrieval in response to an activation of the activation area by a viewer. This object-related information can be derived from external data sources and/or added by a co-ordinator or extracted from the object itself. It can furthermore be included in an assignment arrangement comprising an RFID tag attached to the object, whereby an attachment to the object can also be realized by localizing an RFID tag close to the object so that a recognition system will associate the RFID tag with that very object. Such RFID recognition system can comprise RFID reader devices into whose close proximity the objects are placed and/or a so-called smart antenna array, which can also serve to localize RFID tags and to distinguish between different tags in a given space.

The assignment arrangement can additionally or complementarily be coupled to a camera system connected with an automatic recognition system. By these means, it is possible to automatically assign object-related information to the object and thus to the corresponding activation area. For that purpose, the automatic recognition system uses recognition logics which derive from recognized features of the object certain object-related information. For example, it can derive from the shape of a shoe and its colour the information that this is a men's shoe of a certain brand and may even give the price for this shoe from a price database.

The more complex the settings of the representation scenery, the bigger is the effect of the proposed method of a simplification of the representation scenery setup for a co-ordinator. Thus, the system and method according to the invention can be applied in many different contexts, but with particular advantages in a framework in which the representation scenery is a 3D world model for head and/or gaze tracking and/or in circumstances in which the method is applied to a multitude of activation areas with corresponding objects. In such 3D world model the representation scenery is exactly located where the exhibition scenery is located so that interacting with the objects of the exhibition scenery, e.g. gazing at them, can automatically be recognized as a parallel interaction with the representation scenery.

### BRIEF DESCRIPTION OF THE DRAWINGS

FIG. 1 shows a schematic block diagram of a system according to the invention.

FIG. 2 shows a schematic view of an interactive shop window including features of the invention.

FIG. 3 shows a schematic view of a detail of representation scenery.

In the drawings, like numbers refer to like objects throughout. Objects are not necessarily drawn to scale.

### DETAILED DESCRIPTION OF THE EMBODIMENTS

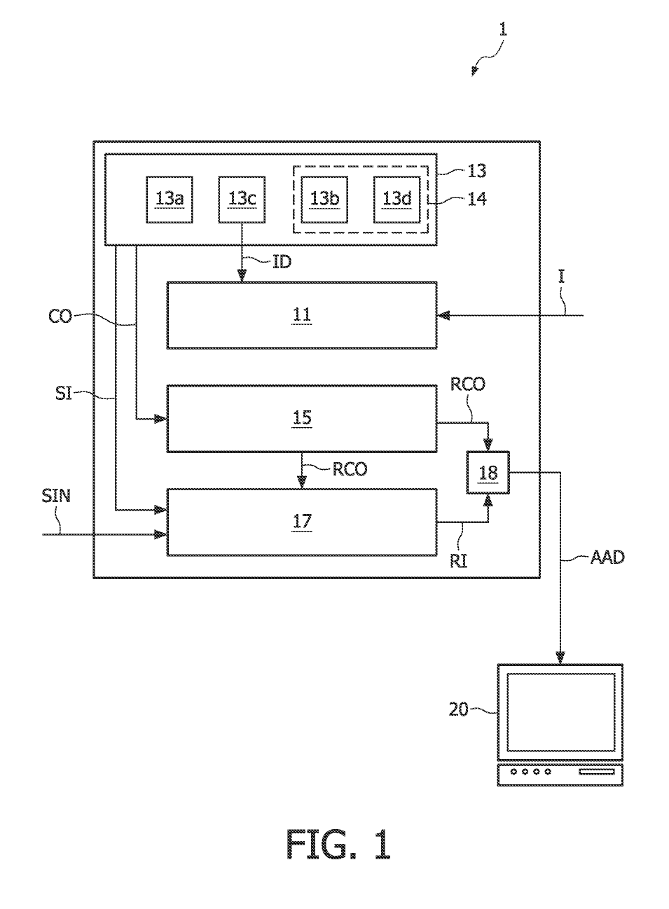

FIG. 1 shows a block diagram of a system 1 for defining an activation area within a representation scenery of a co-ordinator interface according to the invention.

The system comprises a registration unit 11 for registering an object, a measurement system 13 with several optical and electronic units 13a, 13b, 13c, 13d, a determination unit 15 and a region assignment unit 17. The electronic units of the measurement system 13 are a laser device 13a, a camera 13b, an automatic recognition system 13c and an image recognition unit 13d. The camera 13b combined with the image recognition unit 13d also forms an image recognition system 14.

All of these elements can comprise both hardware and software components or one of both. For example, the registration unit 11 can consist of a software unit within a processor unit of a computer system and serves to register an object. For example, a co-ordinator can give an input I defining a certain object, which the registration unit 11 registers. The registration unit 11 can also receive identification data ID of objects from the automatic recognition system 13c or the image recognition system 14, wherefrom it derives registration information about a particular object. Thereby, the image recognition system 14 can recognize images of objects and derive therefrom certain characteristics of the objects such as shape, size, and—if supplied with a database for comparison—information about the nature of the objects. In comparison, the automatic recognition system 13c can receive data from any of the laser device 13a and the camera 13b and maybe other identification arrangements such as RFID systems and can derive therefrom information e.g. about the mere presence of the objects—such as would be necessary in the context of registration—and possibly other object-related identification information such as information about the character of the object, associated advertisement slogans, price, etc. In this context, an RFID system would comprise RFID tags associated with the objects and an RFID antenna system to interact with those RFID tags by means of wireless communication.

Both the laser device 13a and the camera 13b as well as additional or alternative optical and/or electronic devices such as RFID communication systems or ultrasonic measuring devices can serve as measuring means to measure co-ordinates CO of the object within the exhibition scenery. These co-ordinates CO serve as an input for the determination unit 15, which can be a software or hardware information processing entity which determines a position of an activation area within a representation scenery. For that purpose, the logic of the determination unit 15 is such that it will derive from the co-ordinates CO of the object corresponding representation co-ordinates RCO of the activation area. The region assignment unit 17, again usually a software component, will assign a region to the activation area. For that purpose, it may receive information about the shape of the corresponding object from a co-ordinator or the measurement system 13 in the form of manual shape input SIN by a co-ordinator and/or measured shape information SI from the measurement system 13. The region information RI, i.e. information about the region assigned to an object and the representation co-ordinates RCO are collected in a memory 18 handed over in the shape of activation area data ADD. These are visualized for a co-ordinator, in this case by a computer terminal 20.

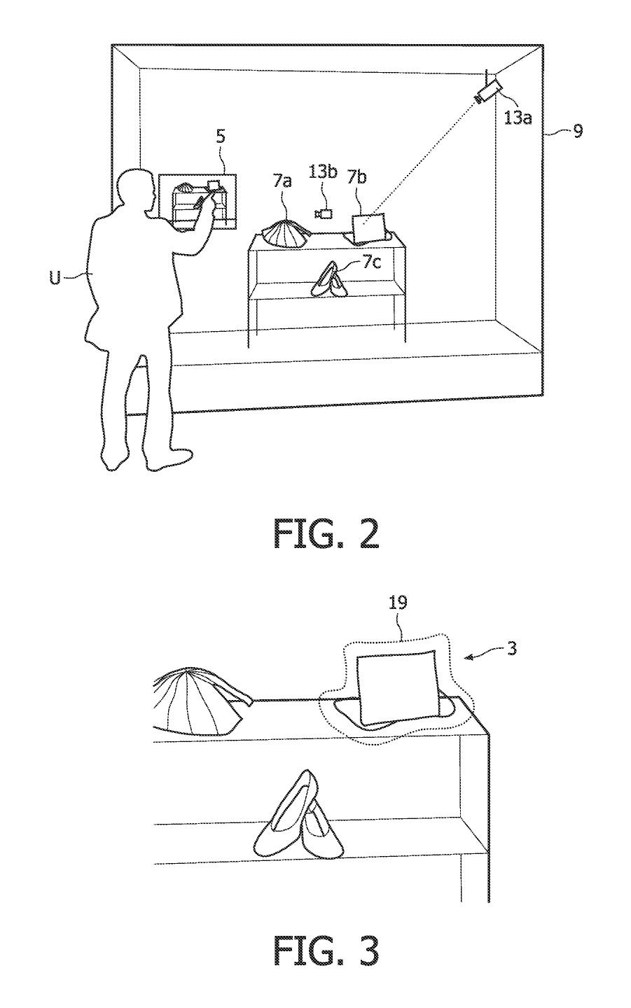

In FIG. 2 is shown such interactive shop window scene with an exhibition scenery 9 and a representation scenery 5. The representation scenery 5 is displayed on a graphical user interface in the form of a touchpanel display. A co-ordinator U can therefore interact with and/or programme the representation scenery 5.

Within the exhibition scenery 9, three objects 7a, 7b, 7c, i.e. two handbags on a top shelf and a pair of lady's shoes on the bottom shelf are displayed. All these objects 7a, 7b, 7c are physical objects, however the invention is not limited to purely physical things but can also be applied to objects such as light displays on a screen or similar objects with a volatile character. In this example, the objects 7a, 7b, 7c are all positioned in one depth level with respect to the co-ordinator U, but they could also be positioned at different depth levels. Hanging from the ceiling of the shop window of the exhibition scene 9 is a laser device 13a and there is also a 3D camera 13b installed in the back wall behind the objects 7a, 7b, 7c. Both these devices 13a, 13b are positioned in such way that they are not occluded by the objects 7a, 7b, 7c. Such positioning can be achieved in many different ways: Another preferred position for the camera 13b is in the top level region above the co-ordinator U in a region in between the co-ordinator U and the objects 7a, 7b, 7c. In such case, the camera 13b can also serve to take pictures of the objects 7a, 7b, 7c which can be used for reproduction in the context of the graphical user interface.

Both the laser device 13a and the camera 13b serve to measure the co-ordinates CO of the objects 7a, 7b, 7c. For that purpose, the laser device 13a is directed with its laser beam at the handbag 7b. It is driven by a step motor which is controlled by the co-ordinator U via the graphical user interface of the representation scenery 5. Once the laser device 13a points at the handbag 7b, the co-ordinator U can confirm his selection to the system 1, e.g. by pressing an “OK” icon on the touchpanel. Subsequently, the angles of the laser beam within a co-ordinate system, which can be imagined to be based in a reference point in the laser device 13a, can be determined by a controller within the laser device 13a. The 3D camera 13b, in addition, can measure the distance between this imagined reference point and the handbag 7b. These data—i.e. at least two angles and a distance—are enough to characterize exactly the location of the handbag 7b and thus to generate its co-ordinates CO. The above-mentioned determination unit 15 of the system 1 will define from these co-ordinates CO the representation co-ordinates RCO of an activation area. For object identification, a co-ordinator can use RFID tags. For that purpose, he needs to establish a correspondence between an activation area and object identification data, that he can select in a user interface from a list of RFID tagged objects.

By repeating this process for every object of interest within the exhibition scenery, the representation scenery is set up with indication of centre point of activation areas in a 3D world model, e.g. for head and/or gaze tracking.

Such activation area 3 representing the handbag 7b of FIG. 2 can be seen in FIG. 3. The representation scenery 5 is shown here in greater detail. Two activation areas for the other two objects 7a, 7c have already been defined, whereas the activation area 3 representing the handbag 7b is currently being defined: its location, represented by its centre point has been assigned with the help of the above-mentioned representation co-ordinates RCO, it has been graphically enhanced by a picture of the handbag 7b, and currently a region 19 is assigned to it by means of a cursor driven by the co-ordinator U using the touchpanel. With the help of the camera 13b and a corresponding image recognition unit 13d as mentioned in the context of FIG. 1, it would also be possible to detect the shape of the handbag 7b and then automatically derive the region 19 therefrom. As can be seen, the region 19 represents the shape of the handbag 7b but its outline is slightly bigger than it would be if it was an exact translation of the shape of the handbag 7b onto the representation scenery scale.

The graphical user interface which is used by the co-ordinator in order to set up the representation scenery 5 can later be utilized as a viewer interface as well and can then give information to a viewer as well as serve as an input device, e.g. for an activation of activation areas 3.

For the sake of clarity, it is to be understood that the use of “a” or “an” throughout this application does not exclude a plurality, and “comprising” does not exclude other steps or elements. A “unit” can comprise a number of units, unless otherwise stated.

1. A system (1) for defining an activation area (3) within a representation scenery (5) of a viewer interface, which activation area (3) represents an object (7a, 7b, 7c) in an exhibition scenery (9), whereby the representation scenery (5) represents the exhibition scenery (9), which system comprises
a registration unit (11) for registering the object (7a, 7b, 7c),
a measuring arrangement (13a, 13b) for measuring co-ordinates (CO) of the object (7a, 7b, 7c) within the exhibition scenery (9),
a determination unit (15) for determining a position of the activation area (3) within the representation scenery (5), which determination unit (15) is realized to assign representation co-ordinates (RCO) to the activation area (3) which are derived from the measured co-ordinates (CO) of the object (7a, 7b, 7c),
a region assignment unit (17) for assigning a region (19) to the activation area (3) at the position of the activation area (3) within the representation scenery (5).

2. A system according to claim 1, comprising at least one laser device (13a) and/or at least one ultrasonic measuring device for measuring the co-ordinates (CO) of the object (7a, 7b, 7c).

3. A system according to claim 1 comprising at least one measuring device directly or indirectly controlled by a co-ordinator (U) for measuring the co-ordinates (CO) of the object (7a, 7b, 7c).

4. A system according to claim 1, which is realized to derive the region (19) which is assigned to the activation area (3) from the shape of the object (7a, 7b, 7c).

5. A system according to claim 4, comprising an imagine recognition system (14) with at least one camera (13b) and an image recognition unit (13d) which determines the shape of the object (7a, 7b, 7c).

6. A system according to claim 5, wherein the image recognition system (14) is realized to register the object (7a, 7b, 7c) by background subtraction.

7. A system according to claim 1, comprising a depth analysis arrangement for a depth analysis of the exhibition scenery (9).

8. A system according to claim 1, comprising a co-ordinator interface for display of the co-ordinates (CO) and/or region (19) assigned to the activation area (3) to a co-ordinator (U) for modification.

9. A system according to claim 1, comprising an assignment arrangement to assign object-related identification information to the object (7a, 7b, 7c) and to its corresponding activation area (3).

10. A system according to claim 9, wherein the assignment arrangement comprises an RFID tag attached to the object (7a, 7b, 7c).

11. A system according to claim 9, wherein the assignment arrangement is coupled to a camera (13b) connected with an automatic recognition system (13c).

12. A system according to claim 1, wherein the representation scenery (5) is a 3D world model for head and/or gaze tracking.

13. Exhibition system with a viewer interface for interactive display of objects (7a, 7b, 7c) in the context of an exhibition scenery (9) with an associated representation scenery (5), which exhibition system comprises a system (1) according to claim 1 for defining an activation area (3) within the representation scenery (5).

14. A method for defining an activation area (3) within a representation scenery (5) of a viewer interface, which activation area (3) represents an object (7a, 7b, 7c) in an exhibition scenery (9), whereby the representation scenery (5) represents the exhibition scenery (9), which method comprises
registering the object (7a, 7b, 7c),
measuring co-ordinates (CO) of the object (7a, 7b, 7c) within the exhibition scenery (9),
determining a position of the activation area (3) within the representation scenery (5) by assigning to it representation co-ordinates (RCO) derived from the measured co-ordinates (CO) of the object (7a, 7b, 7c),
assigning a region (19) to the activation area (3) at the position of the activation area (3) within the representation scenery (5).

15. A method according to claim 1, whereby wherein the method is applied to a multitude of activation areas (3) with corresponding objects (7a, 7b, 7c).
